(19) United States
(12) Patent Application Publication
(10) Pub. No.: US 2008/0244917 A1
(43) Pub. Date: Oct. 9, 2008

(54) Cosmetic Pencil Sharpener

(76) Inventor: Johann Eisen, Mohrendorf (DE)

Correspondence Address: LERNER GREENBERG STEMER LLP, P O BOX 2480, HOLLYWOOD, FL, 33022-2480, US

(21) Appl. No.: 11/547,497

(22) PCT Filed: Aug. 11, 2004
(86) PCT No.: PCT/DE04/01813

§ 371 Date: Nov. 20, 2006

(30) Foreign Application Priority Data
Apr. 1, 2004 (DE) 20 2004 005 040.4

(51) Int. Cl. B43L 23/00

(52) U.S. Cl. 30/454; 30/457; 144/28.11

(57) ABSTRACT

A sharpener, particularly a cosmetic pencil sharpener, contains a sleeve-like sharpener housing whose inside diameter for rotationally guiding the pencil to be sharpened is dimensioned so that it is somewhat larger than the outside diameter and whose inside length is dimensioned in such a manner that it enables a pencil end section to be conically sharpened by a sharpening blade diagonally projecting into the inside cross-section of the sharpener housing. Another sleeve-like housing section is situated at the end of the sharpener housing opposite the insertion end and is separated from the sharpener housing by a partition The inner area of the second housing section is provided in the form of a tight blind bore with an inside diameter approximately corresponding to the outside diameter of the pencil to be sharpened and, in the form of a pencil protector, and can be slid onto the pencil with a press fit.

The invention/innovation relates to a sharpener, in particular a cosmetic pencil sharpener with the additional features of the preamble of claim 1.

Such a sharpener, as finds application in particular in connection with cosmetic pencils, has a sleeve-like sharpener housing, the inside diameter of which is for rotatable guidance dimensioned to be slightly larger than the outside diameter of the pencil to be sharpened. Its internal length is selected in such a way that the pencil end portion can be sharpened conically by a sharpening blade projecting into the internal cross section at an angle.

Such a sharpener is known from U.S. Pat. No. 6,568,090 B2 and is disadvantageous inasmuch as there is a risk, when the sharpener is used as tip protection for the sharpened cosmetic pencil, of the sharpened region of the cosmetic pencil being damaged by blade of the sharpener touching it and-of the pencil lead drying out owing to only inadequate sealing.

The invention/innovation is based on the object of designing a sharpener, in particular a cosmetic pencil sharpener, in such a way that better protection of the sharpened pencil, in particular of a cosmetic pencil, is ensured. This object is achieved by the characterizing features of claim 1, and advantageous developments emerge from the subclaims.

The core of the invention/innovation is considered to be to arrange a further sleeve-like housing portion, which is separated from the sharpener housing by a partition and the interior of which is designed in the manner of a tight blind hole bore, on that end of the sharpener housing facing away from the insertion end. The inside diameter of this further housing portion, which serves as a protector, is to correspond to the outside diameter of the pencil to be sharpened and to be capable of being pushed onto the pencil sealingly with a press fit. Two functions are thus combined in a preferably one-piece sharpener housing, namely a housing portion which seals in relation to the pencil outer wall and, as a pencil protector, protects the tip of the pencil against mechanical damage and drying out. Moreover, this lengthening sharpener housing portion has an advantageous effect during the actual sharpening operation because it can be used as a grip of the sharpener.

In order that the protector is held securely and firmly on the pencil tip, the further housing portion has in its interior conically tapered portions or at least one clamping element which acts resiliently on the outer surface of the pencil in order to prevent the pencil protector slipping down off the pencil.

The insertion end of the sharpener housing can be closed by a closure element. This prevents sharpening residues located in the interior of the sharpener housing coming out and resulting in dirtying of the surrounding environment, for example the interior of a handbag. If the region of the sharpener housing provided with the sharpening blade can be sealed by a lid element, protection against dirtying of storage utensils for the sharpener is improved still further. The lid element is advantageously arranged pivotably about the longitudinal central axis of the sharpener housing as then in the open position it does not project appreciably from the sharpener during the sharpening operation and the sharpener is thus easy to operate. This can be achieved mechanically by holding elements of ring-like design which are mounted on sliding surfaces of the sharpener housing portion.

In order to avoid the lid element being opened unintentionally and releasing sharpening waste, it can be locked in a sealing position.

The sharpener housing and the further sharpener housing portion can be formed by a one-piece molded part made of plastic or metal. The outside diameter of the sharpener housing should correspond approximately to the outside diameter of the protector portion, and the length of the sharpener housing and the length of the protector housing can be approximately the same.

The sharpener has a particularly slender shape if the sharpener housing is overall of cylindrical design and the lid element is as a hollow cylinder mounted rotatably on the sharpener housing. If the hollow cylinder of the lid element is of thin-walled design, the lid element is barely noticeable and does not increase the diameter of the sharpener housing unnecessarily.

In order for it to be possible to empty the sharpener housing of the sharpening waste, a cutout is provided in the lid element, the shape of which is adapted to the shape of a cutting chamber receiving the sharpening blade, the cutout is arranged in a central region of the lid element, and a lower end portion and an upper end portion surround the sharpener housing completely, by virtue of which secure retention of the rotatable lid element on the sharpener housing is ensured.

The grip of the closure element, with which the insertion opening of the sharpener housing can be closed, corresponds essentially to the diameter of the lid element, so that the closed sharpener as well has a slender cylindrical shape overall.

In order to mount the lid element rotatably and in a simple way on the sharpener housing, a circumferential groove, in which a spring-like projection of the lid element engages in the manner of a snap catch connection, is arranged in the region of the insertion end of the sharpener housing. To support this snap catch connection, that end of the lid element surrounding the insertion end of the sharpener housing is drawn around the end portion of the sharpener housing, so that the lid element overlaps the wall of the sharpener housing at least partly.

The invention is explained in greater detail with reference to illustrative embodiments in the drawing figures, in which

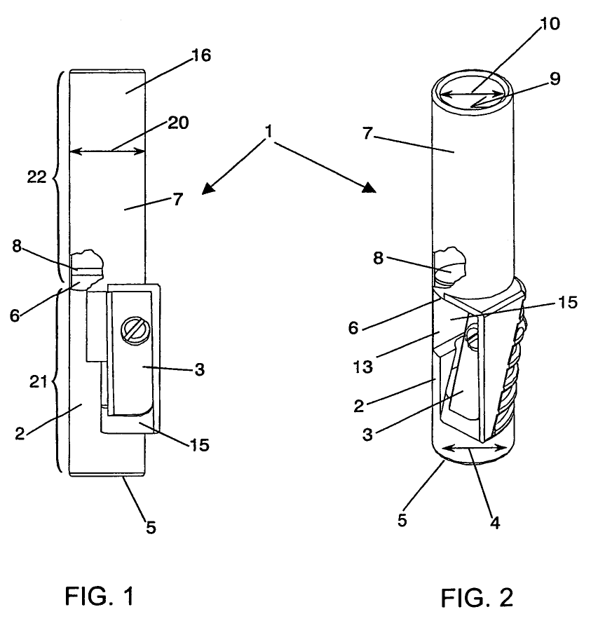

FIG. 1 shows a top view of the front side of the sharpener with the housing cut away in part;

FIG. 2 shows a perspective view of the sharpener with the housing cut away in part;

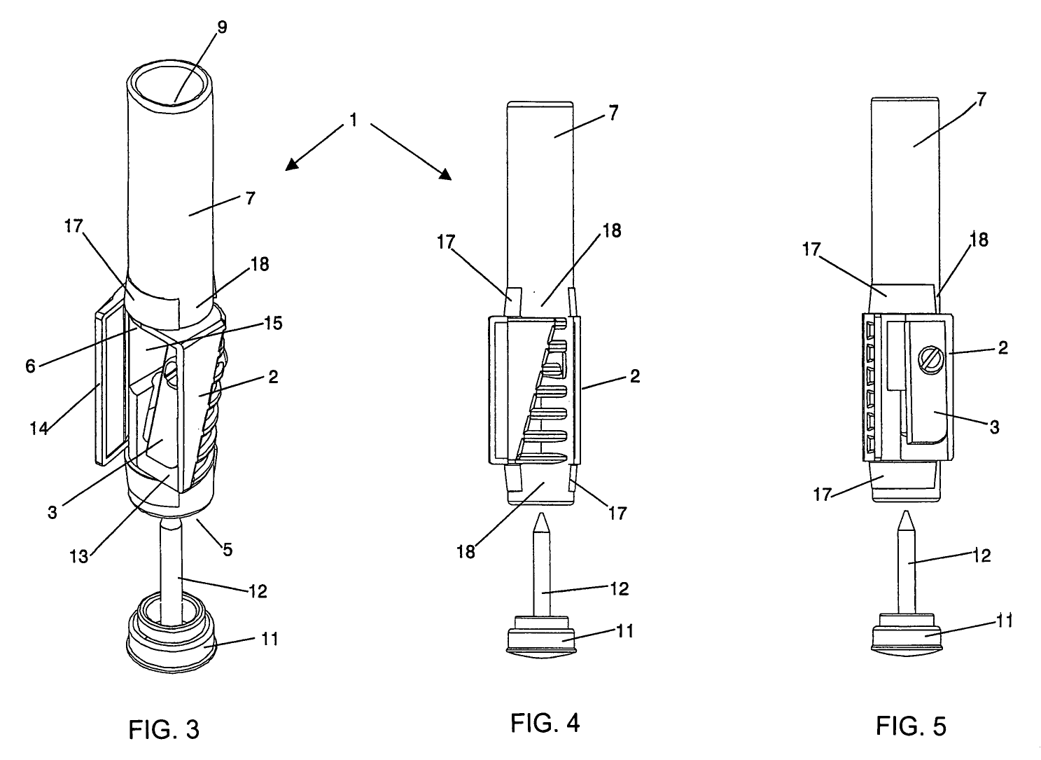

FIG. 3 shows a perspective view of the sharpener with open lid element and closure element;

FIG. 4 shows a rear view of the sharpener;

FIG. 5 shows a front view of the sharpener with open lid element;

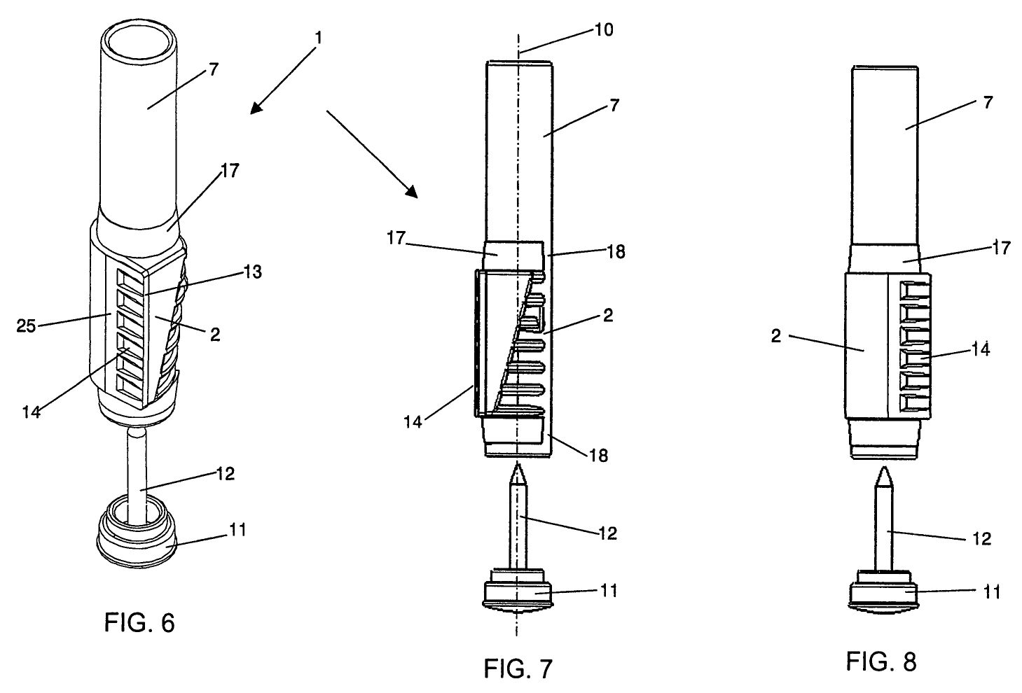

FIG. 6 shows a perspective view of the sharpener with closed lid element;

FIG. 7 shows a first side view of the sharpener with closed lid element;

FIG. 8 shows a further side view of the sharpener with open lid element;

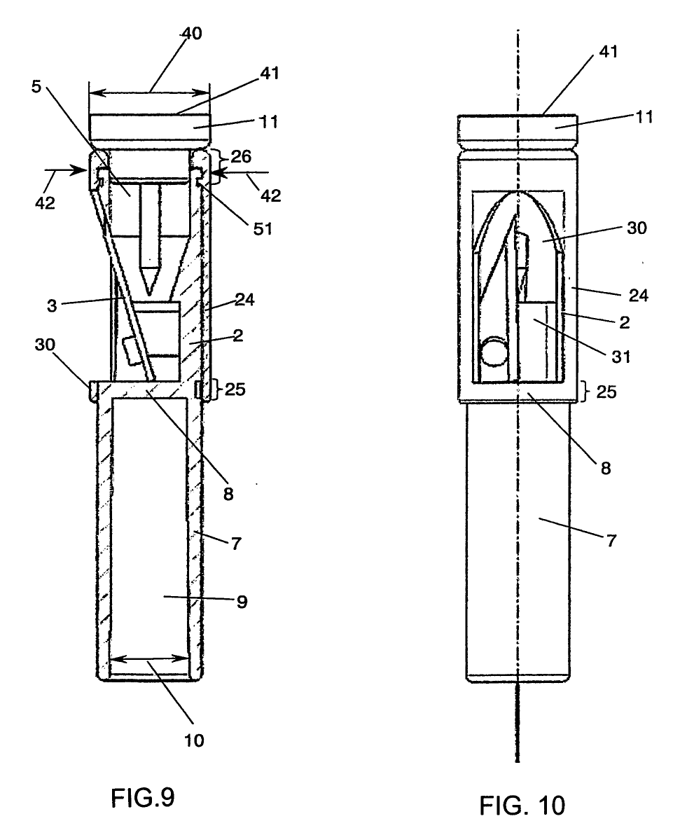

FIG. 9 shows a sectional illustration through a further embodiment of the sharpener;

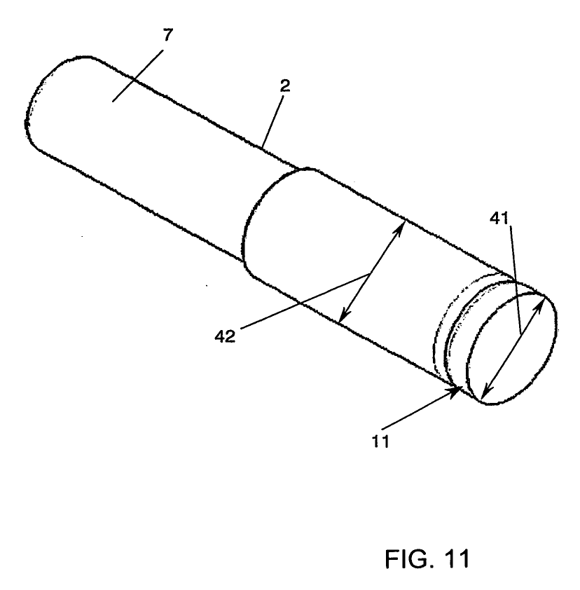

FIG. 10 shows a part-sectional illustration of the sharpener with a top view of the opening of the sharpening chamber, and

FIG. 11 shows a perspective view of the closed sharpener according to FIGS. 9 and 10.

The sharpener 1 has a sleeve-like sharpener housing 2, in which a sharpening blade projecting into the internal cross section at an angle is arranged. The inside diameter 4 of the sharpener housing 2 is, for guiding the pencil to be sharpened, dimensioned to be slightly larger than the outside diameter of the pencil. A further sleeve-like housing portion 7, which is separated from the sharpener housing 2 by a partition 8 and the interior 9 of which is designed in the manner of a tight blind hole bore, is arranged on that end 6 of the sharpener housing 2 facing away from the insertion end. The inside diameter 10 of the housing portion 7 corresponds to the outside diameter of the pencil to be sharpened, so that the housing portion 7 can be pushed onto the pencil with a press fit as a pencil protector.

The interior 9 of the housing portion 7 has a conically tapered portion which ensures secure clamping of the pencil in the interior 9.

Alternatively or additionally, a clamping element can be arranged in the interior 9 of the housing portion 7.

A closure element 11 can be inserted into the insertion end 5 of the sharpener housing 2 in order to close the sharpener housing 2 to prevent sharpening waste falling out. A cleaning pin 12, which projects into the interior of the sharpener housing 2 when the closure element 11 has been inserted, is arranged on the closure element 11. The closure element 11 engages in the insertion opening of the sharpener housing 2 or is retained there with a press fit.

The outer portion 13 of the sharpener housing 2 provided with the sharpening blade 3 is provided with a lid element 14 which in closed position seals a receiving chamber 15 which is arranged outside the sharpening blade. The lid element 14 is pivotable about the longitudinal central axis 16 of the sharpener housing, and holding elements 17 which are claw-like or of ring-like design, surround the sharpener housing 2 and are mounted on sliding surfaces 18 of the sharpener housing 2 are arranged on the lid element 14 for this purpose.

The lid element 14 can be locked in a closed position in which it covers the sharpening blade. The sharpener housing 2 and the housing portion 7 are designed in one piece and consist of a metal or plastic molded part. The outside diameter 20 of the sharpener housing 2 and of the housing portion 7 are approximately the same, as are the respective lengths 21, 22.

The housing portion 7 is designed as a grip element and can for this purpose have a knurled textured exterior (not illustrated in greater detail in the drawing figures). The lid element 14 is provided with a flat outer portion 25, to which impressed or printed advertising can be applied.

The embodiment illustrated in FIGS. 9-11 differs from the embodiment in the previous figures in that the sharpener housing 2 is overall of cylindrical design and the lid element 24 is as a thin-walled hollow cylinder mounted rotatably on the sharpener housing 2. A cutout 30, the shape of which is adapted to the shape of a cutting chamber 31 receiving the sharpening blade, is provided in the lid element 24. The cutout 30 in the lid element 24 is arranged in a central region of the lid element 24, so that a lower end portion and an upper end portion 25, 26 surround the sharpener housing 2 completely.

The diameter 40 of a grip 41 of the closure element 11 corresponds to the outside diameter of the lid element 24.

As can be seen clearly in particular from FIGS. 9 and 10, a circumferential groove 50, in which a spring-like projection 51 of the lid element 24 engages in the manner of a snap catch connection, is provided in the region of the insertion end 5 of the sharpener housing 2.

For visual reasons and in order to support the snap catch connection when the lid element is pushed onto the sharpener housing, that end of the lid element 24 surrounding the insertion end 5 of the sharpener housing 2 is drawn in in such a way that it overlaps the wall of the sharpener housing 2 at least partly.

1-21. (canceled)

22. A sharpener, comprising:
a sharpening blade;
a sleeve-shaped first housing portion having an insertion end, an outer portion, a longitudinal central axis, an internal cross section and an inside diameter for rotatable guidance of a pencil to be sharpened and dimensioned larger than an outside diameter of the pencil, said first housing portion further having an internal length dimensioned such that a pencil end portion can be sharpened conically by said sharpening blade projecting into said internal cross section at an angle;
a partition;
a sleeve-shaped second housing portion separated from said first housing portion by said partition, said second housing portion having an interior configured as a tight blind hole bore with an inside diameter corresponding substantially to the outside diameter of the pencil to be sharpened and can be pushed onto the pencil with a press fit and functioning as a pencil protector, said second housing portion disposed on an end of said first housing portion facing away from said insertion end; and
a lid element sealing said outer portion of said first housing portion provided with said sharpening blade, said lid element pivoting about said longitudinal central axis of said first housing portion.

23. The sharpener according claim 22, said interior of said second housing portion has at least one conically tapered portion.

24. The sharpener according to claim 22, further comprising a clamping element disposed in said interior of said second housing portion.

25. The sharpener according to claim 22, further comprising a closure element inserted into said insertion end of said first housing portion.

26. The sharpener according to claim 22, further comprising holding elements surrounding said first housing portion and disposed on said lid element.

27. The sharpener according to claim 26, wherein said holding elements are one of ring-shaped and claw-shaped and are mounted on sliding surfaces of said first housing portion.

28. The sharpener according to claim 22, wherein said lid element can be locked in a position sealing said first housing portion containing said sharpening blade.

29. The sharpener according to claim 22, wherein said first housing portion and said second housing portion are a one-piece housing.

30. The sharpener according to claim 22, wherein said first housing portion and said second housing portion are a one-piece metal part or a one-piece plastic molded part.

31. The sharpener according to claim 22, wherein said first housing portion and said second housing portion have substantially equivalent outside diameters.

32. The sharpener according to claim 22, wherein said first housing portion and said second housing portion have substantially equivalent lengths.

33. The sharpener according to claim 22, wherein said second housing portion has a grip element and a textured exterior.

34. The sharpener according to claim 22, wherein said lid element has a flat outer portion with an impressed advertising or a printed advertising.

35. The sharpener according to claim 25, wherein said closure element has an inner side and a cleaning element disposed on said inner side.

36. The sharpener according to claim 22, wherein:
said sharpening blade has an outer side; and
said lid element has an inner side, said inner side of said lid element in a closed position and said outer side of said sharpening blade defining a sharpening waste receiving chamber.

37. The sharpener according to claim 22, wherein said first housing portion has a cylindrical shape and said lid element is a thin-walled hollow cylinder mounted rotatably on said first housing portion.

38. The sharpener according to claim 22, wherein:
said first housing portion has a cutting chamber formed therein receiving said sharpening blade; and
said lid element has a cutout formed therein, said cutout having a shape adapted to a shape of said cutting chamber.

39. The sharpener according to claim 38, wherein said cutout in said lid element is disposed in a central region of said lid element, said lid element further having a lower end portion and an upper end portion completely surrounding said first housing portion.

40. The sharpener according to claim 25, wherein said closure element has a grip with a diameter corresponding to a diameter of said lid element.

41. The sharpener according to claim 22, wherein:
said lid element has a spring-shaped projection; and
said first housing portion has a circumferential groove formed therein in a region of said insertion end, said spring-shaped projection of said lid element engaging said circumferential groove in a manner of a snap catch connection.

42. The sharpener according to claim 22, wherein said lid element has an end surrounding said insertion end of said first housing portion and overlaps a wall of said first housing portion at least partly.

43. The sharpener according to claim 22, wherein the sharpener is configured for a cosmetic pencil.
